(19) United States
(12) Patent Application Publication
(10) Pub. No.: US 2022/0018143 A1
(43) Pub. Date: Jan. 20, 2022

(54) Retractable Mezzanine Walkway

(71) Applicant: Lance Pennington, Pine Bush, NY (US)

(72) Inventor: Lance Pennington, Pine Bush, NY (US)

(21) Appl. No.: 17/376,914

(22) Filed: Jul. 15, 2021

Related U.S. Application Data
(60) Provisional application No. 63/052,082, filed on Jul. 15, 2020.

(51) Int. Cl. E04G 3/28; E04G 5/08; A47B 53/02

(52) U.S. Cl. CPC E04G 3/28; A01G 9/1423; A47B 53/02; E04G 5/08

(57) ABSTRACT

It is an object of one or more embodiments of the present disclosure to provide a retractable mezzanine walkway, which when used in conjunction with high-density mobile shelving systems, expands and rolls out, creating an aisle for which employees can walk down. The retractable mezzanine walkway includes pairs of mobile shelving units configured to sit on top of parallel tracks. The retractable mezzanine walkway is configured to roll out between a pair of mobile shelving units when the pair of mobile shelving units is moved apart, such that an aisle is created, and configured to store inside the pair of mobile shelving units when the pair of mobile shelving units are moved together.

This application claims benefit of U.S. Provisional Patent Application No. 63/052,082, filed on Jul. 15, 2020, owned by a common assignee, and which is herein incorporated by reference in its entirety.

### FIELD

The present invention relates generally to walkways and mezzanines, specifically walkways and mezzanines for high-density mobile shelving systems in the vertical farming industry.

### BACKGROUND

Vertical farming, or the act of growing crops in vertically stacked layers, is becoming more and more prevalent, with one increasingly popular application being the growing of cannabis. The allure of being able to grow crops indoors in a controlled environment has made vertical farming the preferred method for many grow operations all over the world. Farmers are looking to utilize every inch of available space, which they do by growing their crops in stacked layers that, depending on the ceiling height, can reach many feet in height. These stacked layers are often on high-density mobile shelving systems. These mobile systems allow farmers to utilize every inch of space available to them, both vertically and horizontally. While vertical farming offers many opportunities and advantages to farmers all over the world, there are also problems unique to this industry that need solutions.

One problem that many vertical farmers are facing is how to safely and efficiently access and care for the crops that are located at higher elevations. Trying to maximize and utilize every square inch of space available to them, vertical farmers often have shelving systems that are over 10 feet in height, or more. The most common solutions to accessing these crops are either by using a ladder or a scissor lift.

Using a ladder to tend crops at higher elevation is a very time consuming and arduous process that requires the ladder to constantly be picked up and moved every couple of feet. Using a ladder that requires constant repositioning creates more work for the employees and puts more strain on their bodies. Some of these mobile shelving runs can stretch over 40 feet in length. Continuous ladder use leads to tired employees, which can lead to unsafe working conditions. It also takes up valuable time that could be allocated elsewhere. While this is the most cost-effective method, it requires both the most physicality and time from the employees.

The other solution most commonly used is a scissor lift, which also is a more time consuming and slow process, requiring a constant adjustment and positioning of the lift. Many of the shelving systems in the vertical farming industry are mobile, meaning they sit on tracks. These scissor lifts, with constant driving across these tracks, can often damage and put unnecessary wear and tear on the tracks. Scissor lifts can also be expensive and require frequent maintenance.

### SUMMARY

While the above solutions are acceptable, a retractable mezzanine walkway solves the problem in a much more efficient and timely manner.

Accordingly, it is an object of one or more embodiments of the present disclosure to provide a retractable mezzanine walkway, for the vertical farming industry, to allow a safe access point for employees to tend to their crops.

It is a further object of one or more embodiments of the disclosure to provide a retractable mezzanine walkway for vertical farmers to efficiently care for their plants at any height.

Still further, it is an object of one or more embodiments of the disclosure to provide a retractable mezzanine walkway to reduce the amount of time vertical farmers need to care for their plants, thus allowing that time to be allocated elsewhere.

Other objects will appear hereinafter.

The above and other objects of the present disclosure may be accomplished in the following manner. A retractable mezzanine walkway is provided, comprising a pair of mobile shelving units, comprising a first and second shelving unit, and an elevated retractable deck between the pair of mobile shelving units, securely connected to the first shelving unit, and slidably connected to the second shelving unit, wherein upon separating the pair of mobile shelving units, the deck forms the walkway between the pair of mobile shelving units.

The above and other objects of the present disclosure may be further accomplished with a method for providing a retractable mezzanine walkway. The steps include assembling a pair of mobile shelving units having an elevated retractable deck between the pair of mobile shelving units. The steps also include moving the pair of mobile shelving units apart to form a mezzanine walkway for use between the pair of mobile shelving units. The steps also include moving the pair of mobile shelving units together such that the elevated retractable deck is stored inside one of the pair of mobile shelving units.

In various embodiments, the retractable mezzanine walkway comprises multiple pairs of mobile shelving units, on parallel tracks.

### BRIEF DESCRIPTION OF THE DRAWINGS

The present disclosure will be more clearly understood from the following description taken in conjunction with the accompanying drawings in which like reference numerals designate similar or corresponding elements, regions and portions and in which:

FIG. 1A shows a perspective view of a retractable mezzanine walkway, for a pair of mobile shelving units, completely rolled out, and ready for use.

FIG. 1B is a front view of a deck attached to a secure beam, which slidably moves on support bracket(s), during opening and closing of the shelving system.

FIG. 1C shows a connection point of the disclosed walkway deck, along a first side of its length, to a secure beam of a first shelving unit of a pair of shelving units.

FIG. 1D shows the grated decking supported, along its width, by a support bracket(s) of a second shelving unit of a pair of shelving units.

FIG. 2A shows a perspective view of two pairs of mobile shelving units, completely rolled out, and ready for use.

FIG. 2B is a perspective view of multiple pairs of shelving units, arranged end-to-end and connected to one another to form a row of walkway decking.

FIG. 3A shows a front view of the retractable mezzanine walkway, completely rolled out, and ready for use.

FIG. 3B is a perspective view of a plastic slide and stopper for the disclosed walkway.

FIG. 4A shows a front view of the retractable mezzanine walkway when it is not rolled out, and when the shelving units are moved together.

FIG. 4B is a front view of a deck attached to a secure beam, which slidably moves on support bracket(s), during opening and closing of the shelving system.

FIG. 5 shows a grated deck preferably used for the walkway.

FIG. 6 is a flow chart of a method of providing a retractable mezzanine walkway.

### DETAILED DESCRIPTION

The present disclosure proposes a retractable mezzanine walkway, especially for the vertical farming industry, to allow a safe access point for employees to tend to their crops, at elevated levels. Furthermore, it is desirable to have a retractable mezzanine walkway because it solves the problem that many vertical farmers face, which is how they can safely and efficiently care for their plants at higher elevations. Additionally, it is desirable to have a retractable mezzanine walkway to reduce the amount of time needed to care for the plants, thus allowing that time to be allocated elsewhere. Therefore, a retractable mezzanine walkway helps to fill many needs and improve many aspects of the vertical farming industry, as well as other applications/industries in which access to higher elevations is needed.

The retractable mezzanine walkway works in conjunction with bulk/pallet racking and/or any shelving on high density systems, specifically those high-density systems that are mobile, meaning the shelving units preferably sit on wheeled carriages on tracks. Due to their ability to utilize all the space available in a given room, the majority of the shelving systems used in the vertical farming industry are mobile. Because they are mobile, each section of shelving can be moved so that an aisle is created, allowing easy access for each section of shelving. When the aisle is closed, and pairs of shelving units are condensed together, the walkway decking is stored inside an adjacent shelving unit of one of the pairs of shelving units. When the aisle is open, it is exposed and rolled out for use.

The disclosed walkway increases productivity by decreasing the amount of time needed to tend crops. Employees will be able to spend more time actually caring for and tending to their crops, rather than spending that time constantly adjusting their means of access, whether that be a ladder or scissor lift. Employees will exert less energy reaching the higher elevations and will be able to harness that energy into more focused and tender care for their crops.

The retractable mezzanine walkway also smoothly rolls out for easy and effortless use. When the shelving sections are rolled apart to create an entry point for employees to access their crops, the walkway simply rolls out as the sections of shelving are separating. Once the walkway has been installed, there is no other maintenance or work that needs to be done for it. If an employee is physically able to move the shelving systems, which all should be able, then they are able to safely layout the retractable mezzanine walkway for use.

Lastly, the retractable mezzanine walkway provides a more stable and safer platform for producing better work and healthier crops. Unlike standing on the top of a ladder or scissor lift, which can often feel unsteady and wobbly, the retractable mezzanine walkway allows for smooth transition up and down the aisle. By having support on a secure beam of a first shelving unit of a pair of shelving units and on support bracket(s) of a second shelving unit of a pair of shelving units, the walkway is strong enough to support a load of up to 500 pounds, with minimal to no deflection.

Not only does the retractable mezzanine walkway allow for easy installation and a more convenient access point for the crops, it also provides employees with a safer, more work-place friendly alternative than the ladders and scissor lifts that most companies use.

The retractable mezzanine walkway is structurally different from other known devices or solutions. More specifically, the retractable mezzanine walkway effortlessly slides into place when needed. The walkway can be put away when it is not needed and rolled out and installed when it is. The walkway works in conjunction with a high-density mobile shelving system. The constant rolling back and forth of high-density systems leaves very little available space for a stationary or set mezzanine walkway system. The aisles are constantly opening and closing, and the system is always being manipulated. The retractable mezzanine walkway allows for the high-density mobile shelving systems to work most effectively and efficiently, while not infringing on the space of the grow. In an industry when every available square footage of space is utilized so that each crop yields as much as possible, a retractable mezzanine walkway is a necessity due to the fact that it doesn't take up any unnecessary space or infringe on the total canopy of each grow.

Additionally, the disclosed walkway is built into the shelving systems. While the other solutions include additional pieces that need to be acquired separately and used in conjunction with the shelving systems, the retractable mezzanine walkway is a built-in solution that requires no extra work to install or use.

This disclosure will provide a more detailed and specific description that will refer to the accompanying drawings. The drawings and specific descriptions of the drawings, as well as any specific or alternative embodiments discussed, are intended to be read in conjunction with the entirety of this disclosure. The retractable mezzanine walkway may, however, be embodied in many different forms and should not be construed as being limited to the embodiments set forth herein; rather, these embodiments are provided by way of illustration only and so that this disclosure will be thorough, complete and fully convey understanding to those skilled in the art.

The retractable mezzanine walkway may be composed of a grated decking material, e.g. fiber-reinforced polymer (FRP), metal, or plastic, that supports a load up to 500 pounds without significant or sustained deflection. The grated decking is permanently connected, along a first side of its length, to a secure beam of a first shelving unit of a pair of shelving units, and may be attached to the beam with screws, spacers, and plastic standoffs from the bottom side of the decking. The grated decking is supported, along its width, by support bracket(s) of a second shelving unit of a pair of shelving units, located opposite the first shelving unit. The grated decking slides across the support bracket(s) with, preferably, first plastic slides, or an equivalent such as ball bearings, attached to the decking's bottom side. Once the grated decking is fully open, it is prevented from opening too far by, preferably, a stopper including a second plastic slide, attached underneath the support brackets, and to a first plastic slide on the decking's bottom side.

The retractable walkway rests dormant inside one of the pairs of shelving units, when closed. There may be multiple pairs of shelving units, arranged end-to-end and connected to one another to form opposing rows, that are mobile and configured to be moved left or right, depending on which side access is needed. When the multiple pairs of shelving units are pushed together and condensed, the retractable walkway sits in the appropriate shelving unit, nestled under a grow tray. When an aisle is accessed by rolling the sections of multiple pairs of shelving units apart, the retractable walkway simply fills the void that is left by the separating sections. The walkway slides into position preferably about 8 feet above ground, or at another height needed for the application. The retractable walkway is accessed from a permanent aisle with either a ladder or scissor lift. Once the expanded shelving system is secured into position, the user enters the grated decking for access to the elevated shelving.

Railing and locking features are provided to be installed at the end of each shelving run to add safety and support. A ladder is also needed to have access to the initial entry point for the retractable mezzanine walkway. This ladder, once positioned at the end of the run, does not have to be moved until an entire run has been tended to and access to the next run is needed.

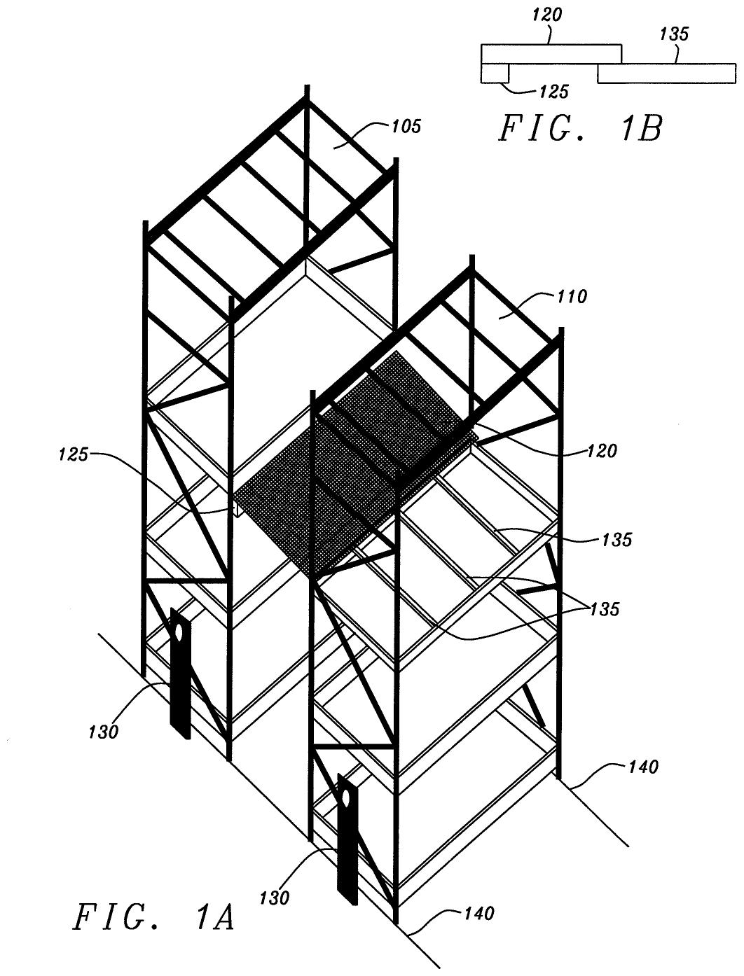

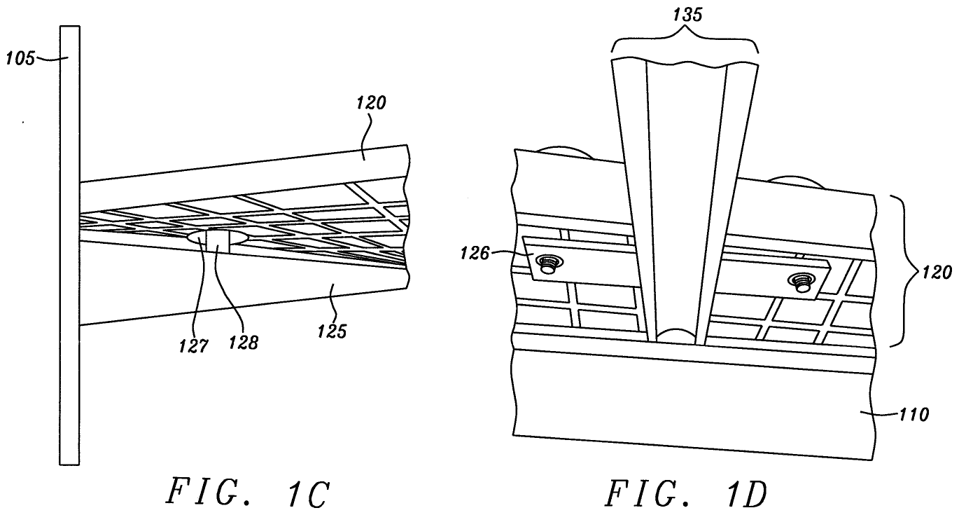

FIG. 1A shows a perspective view of a retractable mezzanine walkway, as part of one pair of opposing shelving units, completely rolled out, and ready for use. The walkway may comprise a grated decking 120, that is permanently connected to secure beam 125 of a first shelving unit 105, along a first side of its length. The grated decking is supported by support bracket(s) 135, along its width, and inside a second shelving unit 110. The grated decking slides along the support bracket(s) of the second shelving unit, when opened. Three support bracket(s) of the second shelving unit are shown, for example, and there could be more or less.

In FIG. 1A, the shelving units have been rolled apart on tracks 140, with mechanical drives 130. The tracks may comprise aluminum strips that are bolted to the floor, and the mechanical drives crank the shelving units to the left or to the right. Wheels (not shown), on the underside of carriages (not shown) to which the shelving units are attached, move the shelving units along the tracks, creating an aisle from which employees can tend to their plants.

FIG. 1B is a front view of deck 120, attached to secure beam 125, which slidably moves on support bracket(s) 135, during opening and closing of the shelving system.

FIG. 1C shows an underside of the grated decking and a connection point, along a first side of its length, to a secure beam 125 of a first shelving unit 105 of a pair of shelving units. The grated decking is permanently attached to the secure beam with screws or bolts (not shown), placed through spacers 127, and plastic standoffs 128. In FIG. 1C, the grated decking of the walkway is fixedly attached to the underlying secure beam at, for example, three places, though more or fewer connections could be made.

FIG. 1D shows the grated decking 120 supported, along its width, by support bracket(s) 135 of a second shelving unit 110 of a pair of shelving units, located opposite the first shelving unit. The grated decking slides across the support bracket(s) with first plastic slides 126, or an equivalent such as ball bearings, attached to the decking's bottom side. The plastic slides are attached to the walkway in two places 132, with bolts, spacers, and nuts.

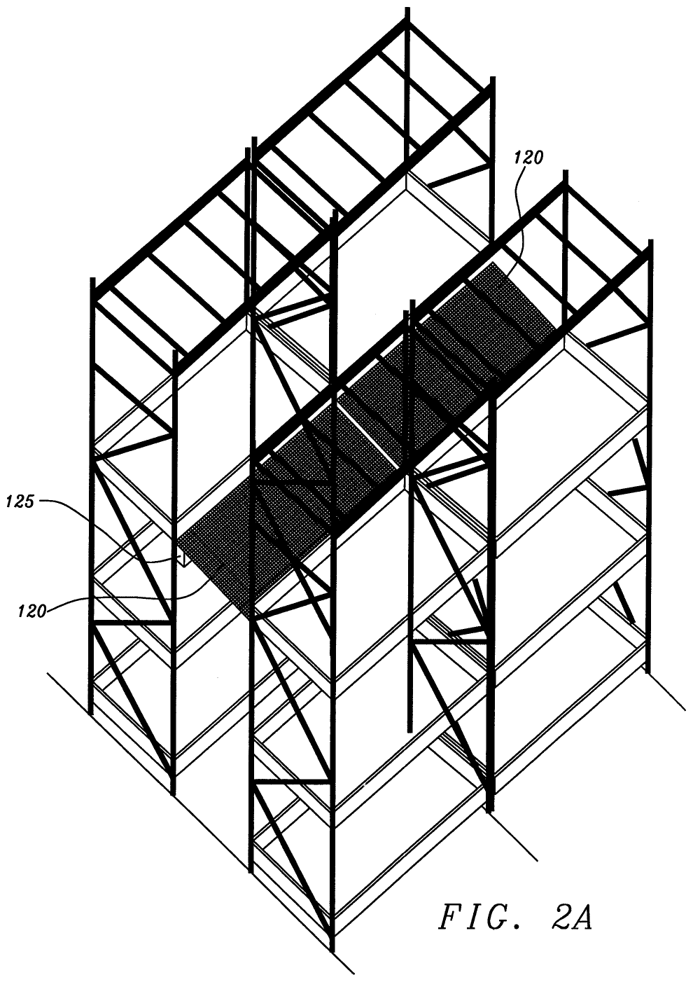

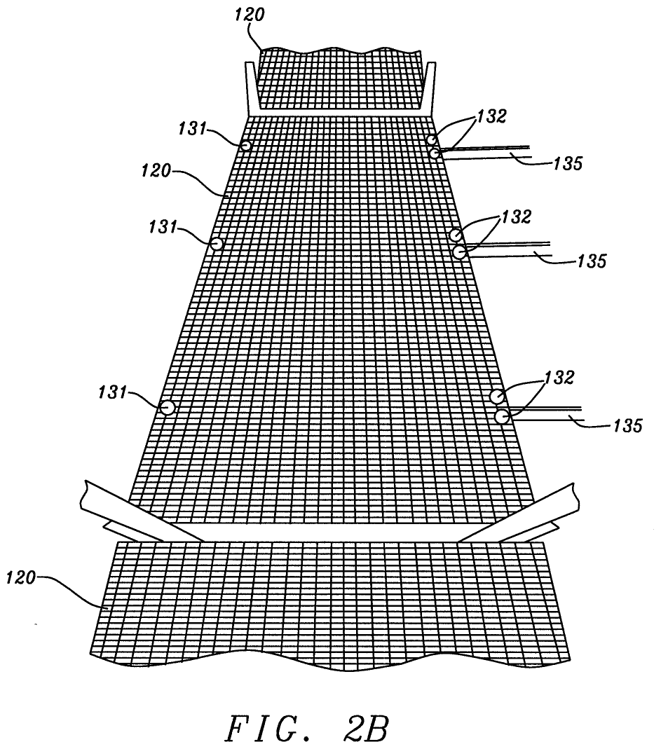

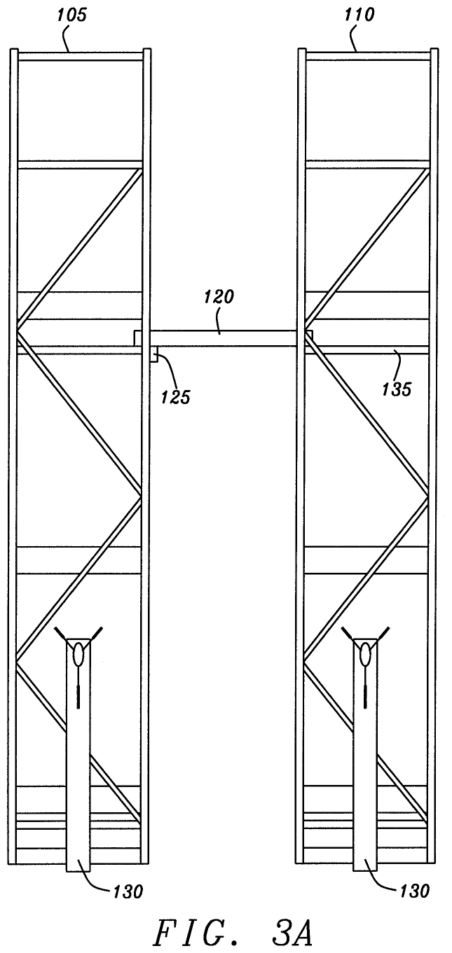

FIG. 2A shows a perspective view of two pairs of mobile shelving units, completely rolled out, and ready for use. Here, the retractable mezzanine walkway comprises two grated decking sections 120 from two pairs of mobile shelving units sitting on parallel tracks. Note that multiple pairs of tracks may be used in the walkway. More than two (N) pairs of mobile shelving units may be connected together, with one walkway section per pair, to form two opposing rows of shelving systems. The rows would be opened or closed all together, with the N walkway sections lined up to form one contiguous walkway for the entire length of N shelving unit pairs.

FIG. 2B is a perspective view of multiple pairs of shelving units, arranged end-to-end and connected to one another to form a row of walkway decking. When an aisle is accessed by rolling the sections of multiple pairs of shelving units apart, the retractable mezzanine walkway fills the void left by the separating sections, with an acceptably small gap between adjacent decking. The grated decking 120 is permanently attached to the secure beam with screws (or bolts) 131, spacers 127, and plastic standoffs 128. The grated decking slides across the support bracket(s) 135 with first plastic slides 126, attached to the underside of the deck with bolts 132.

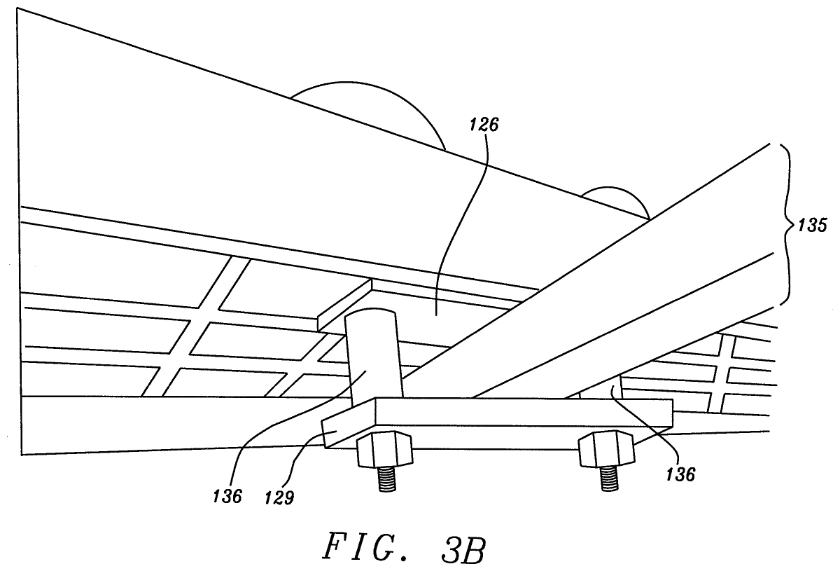

FIG. 3A shows a front view of the retractable mezzanine walkway, completely rolled out, and ready for use. This view illustrates how the grated decking is positioned relative to the shelving units 105 and 110, and where support bracket(s) sit in relationship to the rest of the system. FIG. 3A shows a fully expanded system, where the grated decking is permanently connected to secure beam 125 of a first shelving unit 105, by screws (or bolts) 131 along its length and is supported by support bracket(s) 135 inside a second shelving unit 110. Mechanical assists 130 are used to open and close a row of the shelving system, and are connected to a mechanical shaft drive, with the shaft (not shown) running lengthwise through each row of shelving units.

During opening, the walkway reaches its maximum width based on the stopper positioning and also by chains (not shown) installed at one end of the deck/walkway. The shelving systems can be locked in place by a locking mechanism in the mechanical assist(s) 130.

FIG. 3B is a perspective view of a plastic slide and stopper for the disclosed walkway. FIG. 3B shows how once the grated decking is fully open, it is prevented from opening too far by a stopper, which preferably includes second plastic slides. Second plastic slides 129 are attached underneath the support bracket(s) 135, and to the first plastic slides 126 to provide a stopping mechanism. A preferred embodiment is for this to be connected to the center support bracket of the second shelving unit of a pair of shelving units. The stopping mechanism comprises two each of a spacer, plastic standoff 136, screw, and nut, and is configured to provide movement along the top side of the support bracket.

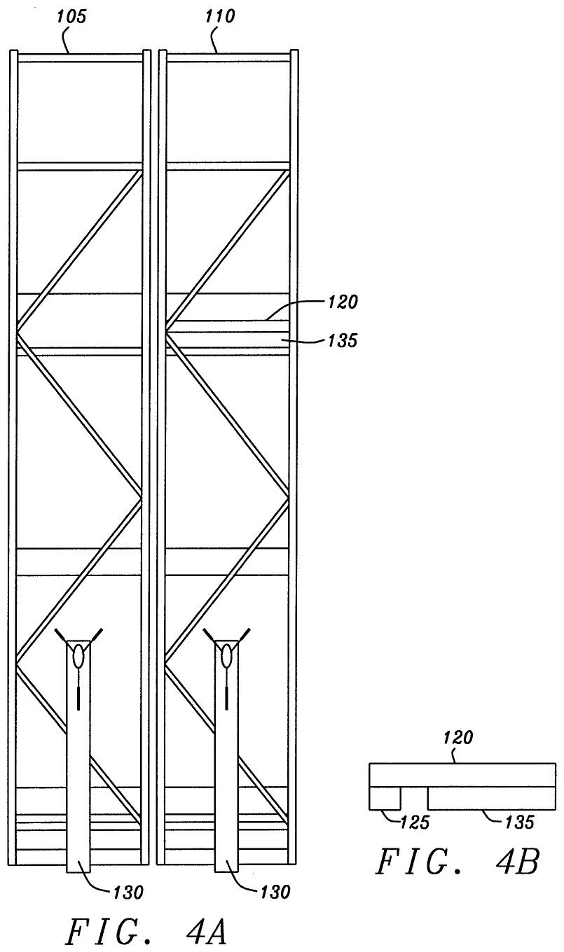

FIG. 4A is a front view of the retractable mezzanine walkway when it is not rolled out, i.e., when the shelving units are moved together. Here no aisle is created, and grated decking 120 sits inside shelving unit 110, supported by support bracket(s) 135, and permanently attached to secure beam 125 of shelving unit 105.

FIG. 4B is a front view of deck 120, attached to secure beam 125, which slidably moves on support bracket(s) 135, during opening and closing of the shelving system.

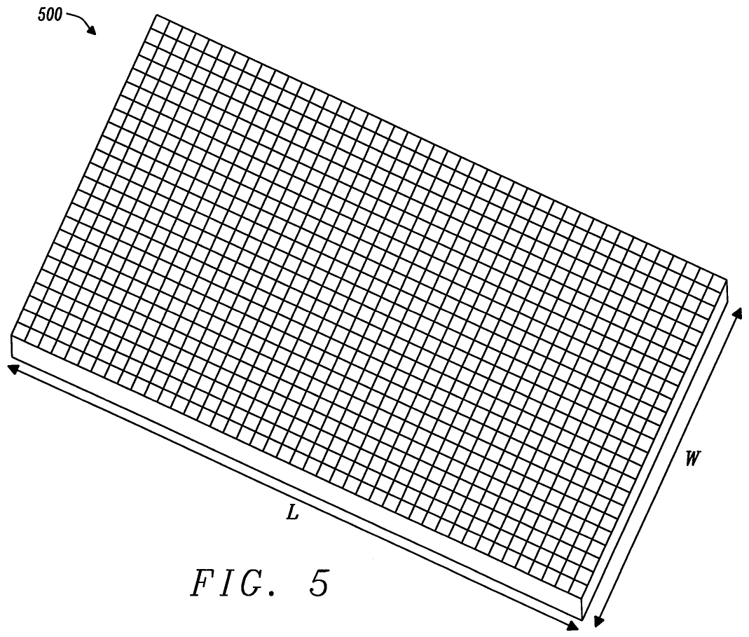

FIG. 5 shows 500, a grated deck preferably used for the walkway. The grated decking is cut to fit to the size of the section of shelving that it is being used for. In other words, if a section of shelving is, for example 4×8 (W×L) feet, the grated decking is cut to about 8 feet in length, and to a desired walkway width, so that the decking fills an aisle left when the shelving units are rolled apart. The walkway width is preferably about 42-43 inches. The grated decking preferably comprises a fiberglass composite material, such as fiber-reinforced polymer (FRP), that works well because of its ability to withstand deflection. Other types of decking material may also be used, such as steel, as long as they can supply the needed load.

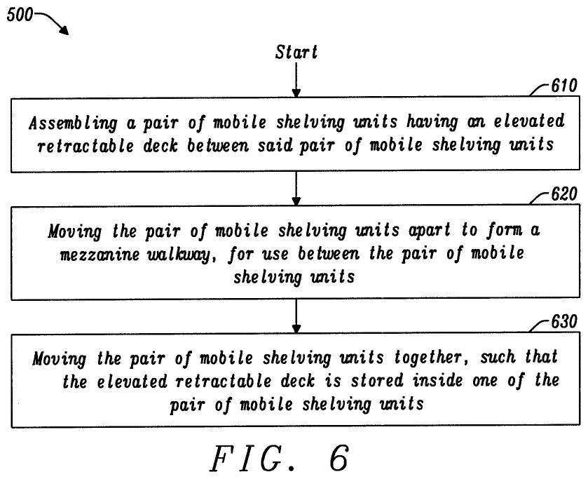

FIG. 6 is flow chart 600, a method of providing a retractable mezzanine walkway. The method comprises step 610, assembling a pair of mobile shelving units having an elevated retractable deck between the pair of mobile shelving units. The method also comprises step 620, moving the pair of mobile shelving units apart to form a mezzanine walkway for use between the pair of mobile shelving units. The method also comprises step 630, moving the pair of mobile shelving units together such that the elevated retractable deck is stored inside one of the pair of mobile shelving units.

One example of the construction of the mobile shelving unit with the retractable mezzanine walkway could comprise the following steps.

Step 1, building the frame of the shelving unit, and adding shelves up to where the grated decking will be placed.

Step 2, preparing the grated decking by installing plastic slides or ball bearings on one side of the grated decking.

Step 3, placing, for example, three plastic slides or ball bearings one row from a long side of the grated decking and three rows from a short side (the middle plastic slide or ball bearing is placed, for example, one row from center).

Step 4, placing the grated decking on a secure beam on one side of a shelving unit.

Step 5, lining up support bracket(s) on an adjacent shelving unit.

Step 6, installing support bracket anchors on the grated decking side that aligns with the support bracket(s), and aligning the support bracket anchors with the plastic strips or ball bearings.

Step 7, slipping one side of the support bracket over the support bracket anchor, and securing the support bracket with self-driving screws.

Step 8, sliding the grated decking from the secure beam side to the support bracket side, and leaving, for example, the second hole from the end over the top of the support bracket.

Step 9, anchoring the grated decking to the secure beam, such that the grated decking is fully atop the secure beam.

Step 10, lining up the grated decking to ensure there is no rubbing during movement.

Step 11, attaching the grated decking to the secure beam with screws, spacers, and plastic standoffs.

Step 12, installing a stopping mechanism on the bottom side of the grated decking.

The main advantage of one or more embodiments of the present disclosure include that the retractable mezzanine walkway rests dormant in the shelving unit. These shelving units are mobile and can be moved to the left or right depending on which side access is needed. When the shelving units are pushed together and condensed, the retractable mezzanine walkway sits in the appropriate shelving unit, nestled under a grow tray. When an aisle is accessed by rolling the sections of shelving apart, the retractable mezzanine walkway simply fills the void that is left by the separating sections. The walkway slides into position approximately 8′ above ground, or whatever height works best for the application, since the decking can be placed at any height. The grated decking is accessed from the permanent aisle with either a ladder or scissor lift. When secured into place, the user enters the deck for access to the elevated shelving.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

What is claimed is:

1. A retractable mezzanine walkway, comprising:
a first pair of mobile shelving units, comprising a first and second shelving unit; and
an elevated retractable deck between said pair of mobile shelving units, securely connected to said first shelving unit, and slidably connected to said second shelving unit;
wherein upon separating said first pair of mobile shelving units, said deck forms said walkway between said pair of mobile shelving units.

2. The retractable mezzanine walkway of claim 1, wherein the elevated retractable deck comprises grated decking.

3. The retractable mezzanine walkway of claim 3, wherein the grated decking comprises a fiber-reinforced polymer (FRP).

4. The retractable mezzanine walkway of claim 1, wherein said elevated retractable deck comprises metal or plastic.

5. The retractable mezzanine walkway of claim 1, wherein, a first length of the elevated retractable deck attaches to a secure beam on said first shelving unit.

6. The retractable mezzanine walkway of claim 5, wherein a second length of the elevated retractable deck, opposite the first length, has one or more plastic strips attached on an underside of said deck, for sliding on one or more support bracket(s) of said second shelving unit.

7. The retractable mezzanine walkway of claim 6, further comprising a stop, used during opening of said walkway, wherein said stop connects under one of said support brackets to said elevated retractable deck.

8. The retractable mezzanine walkway of claim 1, wherein the elevated retractable deck is stored within said second shelving unit when said first pair of mobile shelving units are closed.

9. The retractable mezzanine walkway of claim 1, further comprising one or more additional said pairs of mobile shelving units, formed in two parallel rows, and in parallel with said first pair of mobile shelving units, wherein each pair comprises one of said elevated retractable decks and said elevated retractable decks align to form an extended walkway.

10. The retractable mezzanine walkway of claim 9, further comprising one or more additional rows of mobile shelving units, parallel to said two parallel rows.

11. The retractable mezzanine walkway of claim 10, further comprising tracks attached at a ground level, wherein said tracks are perpendicular to said parallel rows of mobile shelving units and said mobile shelving units are configured to move along said tracks when said mobile shelving units are opened and closed.

12. The retractable mezzanine walkway of claim 1, further comprising a mechanical assist configured to move said mobile shelving units apart and together.

13. The retractable mezzanine walkway of claim 1, wherein said elevated retractable deck is located at a height to allow for users to walk, at ground level, underneath said mezzanine walkway.

14. A method for using a retractable mezzanine walkway, comprising the steps of:
assembling a pair of mobile shelving units having an elevated retractable deck between said pair of mobile shelving units;
moving the pair of mobile shelving units apart to form a mezzanine walkway, for use between the pair of mobile shelving units; and
moving the pair of mobile shelving units together, such that the elevated retractable deck is stored inside one of the pair of mobile shelving units.

15. The method of claim 14, wherein the elevated retractable deck is fixedly attached to a secure beam on one of said pair of mobile shelving units.

16. The method of claim 14, wherein the elevated retractable deck is slidably connected to support beams on one of said pair of mobile shelving units.

17. The method of claim 14, further comprising one or more additional said pairs of mobile shelving units, formed in two parallel rows, and in parallel with said first pair of mobile shelving units, wherein each pair comprises one of said decks and said decks align to form an extended walkway.

18. The method of claim 17, further comprising tracks attached at a ground level, wherein said tracks are perpendicular to said parallel rows of mobile shelving units and said mobile shelving units move along said tracks during said moving apart and together.

19. The method of claim 14, further comprising:
providing a mechanical assist; and
using said mechanical assist to move said mobile shelving units apart and together.

20. A method for assembling a retractable mezzanine walkway, comprising:
building a pair of mobile shelving units, comprising first and second mobile shelving units;
installing one or more support brackets on said second mobile shelving unit;
installing one or more slideable mechanisms to an underside of an elevated retractable deck, to align with said one or more support brackets;
installing a stopping mechanism to said underside of said elevated retractable deck; and
securing said elevated retractable deck to said first mobile shelving unit and placing an opposite side of said elevated retractable deck on said support brackets.
